(19) United States
(12) Patent Application Publication
(10) Pub. No.: US 2021/0385102 A1
(43) Pub. Date: Dec. 9, 2021

(54) ELECTRONIC APPARATUS, SYSTEM AND METHOD FOR PROVIDING SERVICE BASED ON INTERNET OF THINGS

(71) Applicant: Samsung Electronics Co., Ltd., Suwon-si, Gyeonggi-do (KR)

(72) Inventors: Jihwan SEO, Suwon-si (KR); Daeken KWON, Suwon-si (KR); Jihun HA, Suwon-si (KR)

(21) Appl. No.: 17/286,981

(22) PCT Filed: Dec. 24, 2019
(86) PCT No.: PCT/KR2019/018428

§ 371 Date: Apr. 20, 2021

(30) Foreign Application Priority Data
Jan. 17, 2019 (KR) 10-2019-0006348

(51) Int. Cl. H04L 12/28; H04L 29/08

(52) U.S. Cl. CPC H04L 12/2814; H04L 12/282; H04L 2012/285; H04L 2012/2841; H04L 67/125

(57) ABSTRACT

Provided are an electronic apparatus and a method thereof. The electronic apparatus forming an internet of things (IoT) environment includes a communicator, and a processor to, from among a plurality of electronic apparatuses forming the IoT environment, identify a first electronic apparatus that is capable of performing a first sub-service among a plurality of sub-services to provide a service, control the communicator to transmit, to the first electronic apparatus, information on a first application for performing the first sub-service that is received from a server, receive, from the server, a second application for performing a second sub-service which the electronic apparatus is capable of performing, among the plurality of sub-services, through the communicator, and perform the second sub-service through the received second application to provide the service in association with the first electronic apparatus that performs the first sub-service based on information on the first application.

### TECHNICAL FIELD

This disclosure relates to an electronic apparatus and a method thereof and, more particularly, to an electronic apparatus that provides a service based on Internet of Things (IoT), a system, and a method thereof.

### BACKGROUND ART

Recently, in accordance with the development of information communication technology, technologies that utilize a variety of IoT environments are expected to become popularized.

IoT technology is highly used for the purpose of controlling a variety of electronic apparatuses at a household. A user is may control electronic apparatuses such as a TV, a washing machine, an air conditioner, or the like, to perform a specialized service in the IoT environment at home, and may share information easily.

In particular, the IoT technology allows a plurality of electronic apparatuses that form the IoT environment to connect and perform sub-services related to one service and may provide a synergy effect in providing one service, accordingly.

In order to establish such IoT environment, it is required that, in each of a plurality of electronic apparatuses, an application capable of providing sub-services is installed (or distributed).

However, there is an inconvenience that a user should install the application for each of a plurality of electronic apparatuses, and in the case of an electronic apparatus that is not capable of communicating with the server, the user should install the application directly on the electronic apparatus that may not communicate with a server through another medium.

In addition, when an electronic apparatus that controls a specific electronic apparatus among the plurality of electronic apparatuses constituting the IoT environment departs from the IoT environment, there is a problem that the user needs to set the IoT environment on the alternative electronic apparatus and install the required application to control the specific electronic apparatus

### DISCLOSURE OF INVENTION

### Technical Problem

The disclosure provides an electronic apparatus that provides a service based on internet of things (IoT), a system, and a method thereof.

### Solution to Problem

According to an embodiment, an electronic apparatus includes a communicator, and a processor to, from among a plurality of electronic apparatuses forming the IoT environment, identify a first electronic apparatus that is capable of performing a first sub-service among a plurality of sub-services to provide a service, control the communicator to transmit, to the first electronic apparatus, information on a first application for performing the first sub-service that is received from a server, receive, from the server, a second application for performing a second sub-service which the electronic apparatus is capable of performing, among the plurality of sub-services, through the communicator, and perform the second sub-service through the received second application, in order to provide the service in association with the first electronic apparatus that performs the first sub-service based on information on the first application.

The information on the first application may include at least one of a package to install the first application or a uniform resource locator (URL) to receive the package from the server.

The processor may install the received second application in the electronic apparatus and perform the second sub-service by executing the installed second application.

The processor may identify the first electronic apparatus that is capable of performing the first sub-service, among the plurality of electronic apparatuses, based on information on the plurality of electronic apparatuses that is received from the plurality of electronic apparatuses through the communicator.

The processor may identify whether there is an alternative electronic apparatus that is capable of performing the second sub-service among the plurality of electronic apparatuses, and based on the alternative electronic apparatus that is capable of performing the second sub-service existing, control the communicator to transmit the received information on the second application to the alternative electronic apparatus, and the alternative electronic apparatus may perform the second sub-service based on the information on the second application received from the electronic apparatus, in order to provide the service in association with the electronic apparatus that performs the first sub-service based on the information on the first application.

The processor may, based on the alternative electronic apparatus performing the second sub-service, control not to perform the second sub-service through the second application.

The processor may, based on receiving an instruction to request a third application for performing a third sub-service from a second electronic apparatus among the plurality of electronic apparatuses, receive, from the server, information on the third application through the communicator, control the communicator to transmit the received information on the third application to the second electronic apparatus that transmits the instruction, and the second electronic apparatus may perform the third sub-service based on the information on the third application that is received from the electronic apparatus, in order to provide a service in association with a different electronic apparatus among the plurality of electronic apparatuses.

The processor may receive, from the server, a fourth application corresponding to a fourth sub-service to provide a service through the communicator, and perform the fourth sub-service through the received fourth application, in order to provide the service in association with a third electronic apparatus that obtains information for the fourth sub-service, among the plurality of electronic apparatuses.

The processor may receive, from the third electronic apparatus, information for the fourth sub-service that is received by the third electronic apparatus, and perform the fourth sub-service through the received fourth application based on the received information for the fourth sub-service.

According to an embodiment, an IoT system including a plurality of electronic apparatuses forming the IoT environment includes a first electronic apparatus, and a second electronic apparatus to perform a first sub-service based on information on a first application that is received from the first electronic apparatus, and the first electronic apparatus may identify the second electronic apparatus that is capable of performing a first sub-service among a plurality of sub-services to provide a service, among the plurality of electronic apparatuses, based on receiving information on a first application for the first sub-service from a server, transmit information on the first application to the second electronic apparatus, receive, from the server, a second application for a second sub-service which the first electronic apparatus is capable of performing, among the plurality of sub-services, and perform the second sub-service through the received second application, in order to provide the service in association with the second electronic apparatus that performs the first sub-service based on the information on the first application.

According to an embodiment, a controlling method of an electronic apparatus forming an internet of things (IoT) environment may include, from among a plurality of electronic apparatuses forming the IoT environment, identifying a first electronic apparatus that is capable of performing a first sub-service among a plurality of sub-services to provide a service; transmitting, to the first electronic apparatus, information on a first application for performing the first sub-service that is received from a server; receiving, from the server, a second application for performing a second sub-service which the electronic apparatus is capable of performing, among the plurality of sub-services; and performing the second sub-service through the received second application, in order to provide the service in association with the first electronic apparatus that performs the first sub-service based on information on the first application.

The information on the first application may include at least one of a package to install the first application or a uniform resource locator (URL) to receive the package from the server.

The performing the second sub-service may further include installing the received second application and performing the second sub-service by executing the installed second application.

The identifying the first electronic apparatus may include identifying the first electronic apparatus that is capable of performing the first sub-service, among the plurality of electronic apparatuses, based on information on the plurality of electronic apparatuses that is received from the plurality of electronic apparatuses through the communicator.

The method may include identifying whether there is an alternative electronic apparatus that is capable of performing the second sub-service among the plurality of electronic apparatuses; and based on the alternative electronic apparatus that is capable of performing the second sub-service existing, transmitting the received information on the second application to the alternative electronic apparatus, and the alternative electronic apparatus may perform the second sub-service based on the information on the second application received from the electronic apparatus, in order to provide the service in association with the electronic apparatus that performs the first sub-service based on the information on the first application.

The performing the second sub-service may include, based on the alternative electronic apparatus performing the second sub-service, controlling not to perform the second sub-service through the second application.

The method may include, based on receiving an instruction to request a third application for performing a third sub-service from a second electronic apparatus among the plurality of electronic apparatuses, receiving, from the server, information on the third application through the communicator, and transmitting the received information on the third application to the second electronic apparatus that transmits the instruction, and the second electronic apparatus may perform the third sub-service based on the information on the third application that is received from the electronic apparatus, in order to provide a service in association with a different electronic apparatus among the plurality of electronic apparatuses.

The method may further include receiving, from the server, a fourth application corresponding to a fourth sub-service to provide a service through the communicator, and performing the fourth sub-service through the received fourth application, in order to provide the service in association with a third electronic apparatus that obtains information for the fourth sub-service, among the plurality of electronic apparatuses.

The performing the fourth sub-service may include receiving, from the third electronic apparatus, information for the fourth sub-service that is received by the third electronic apparatus, and performing the fourth sub-service through the received fourth application based on the received information for the fourth sub-service.

### Advantageous Effects of Invention

According to various embodiments as described above, provided is an electronic apparatus that provide a service based on the IoT, a system, and a method thereof.

### BRIEF DESCRIPTION OF DRAWINGS

FIG. 1 is a view of the IoT environment, according to an embodiment;

FIG. 2 is a block diagram of an electronic apparatus, according to an embodiment;

FIG. 3 is a view to describe a sequence of performing a sub-service by an electronic apparatus, according to an embodiment;

FIG. 4 is a view to describe a sequence of performing a sub-service by an electronic apparatus, according to an embodiment;

FIG. 5 is a view to describe a sequence of performing a sub-service by an electronic apparatus, according to an embodiment;

FIG. 6 is a view to describe a sequence of performing a sub-service by an electronic apparatus, according to an embodiment;

FIG. 7 is a view to describe an electronic apparatus, according to an embodiment;

FIG. 8 is a view to describe an electronic apparatus, according to an embodiment;

FIG. 9 is a view to describe an electronic apparatus, according to an embodiment;

FIG. 10 is a view to describe an electronic apparatus, according to an embodiment;

FIG. 11 is a block diagram which illustrates a configuration of an electronic apparatus in detail, according to an embodiment;

FIG. 12 is a view to describe a system, according to an embodiment;

FIG. 13 is a block diagram, according to an embodiment; and

FIG. 14 is a view to describe a flowchart according to an embodiment.

### MODE FOR THE INVENTION

In describing the disclosure, when it is identified that a detailed description of a related known function or configuration may unnecessarily obscure the subject matter of the disclosure, a detailed description thereof will be omitted. In addition, the following embodiments may be modified in many different forms, and the scope of the technical spirit of the disclosure is not limited to the following embodiments. Rather, these embodiments are provided so that this disclosure will be thorough and complete, and will fully convey the inventive concept to those skilled in the art.

Hereinafter, embodiments of the disclosure will be described with reference to the accompanying drawings. However, this disclosure is not intended to limit the embodiments described herein but includes various modifications, equivalents, and/or alternatives. In the context of the description of the drawings, like reference numerals may be used for similar components.

The expressions such as “the first,” “the second,” “first order,” and “second order” are used to modify various components regardless of the order and/or importance and are used to distinguish one component from another, but do not limit the components.

In this document, the expressions “A or B,” “at least one of A and/or B,” or “one or more of A and/or B,” and the like include all possible combinations of the listed items. For example, “A or B,” “at least one of A and B,” or “at least one of A or B” includes (1) at least one A, (2) at least one B, (3) at least one A and at least one B all together.

A singular expression includes a plural expression, unless otherwise specified. It is to be understood that the terms such as “comprise” or “consist of” are used herein to designate a presence of characteristic, number, operation, element, component, or a combination thereof, and not to preclude a presence or a possibility of adding one or more of other characteristics, numbers, operations, elements, components or a combination thereof.

It is to be understood that an element (e.g., a first element) is “operatively or communicatively coupled with/to” another element (e.g., a second element) is that any such element may be directly connected to the other element or may be connected via another element (e.g., a third element). On the other hand, when an element (e.g., a first element) is “directly connected” or “directly accessed” to another element (e.g., a second element), it can be understood that there is no other element (e.g., a third element) between the other elements.

Herein, the expression “configured to” can be used interchangeably with, for example, “suitable for,” “having the capacity to,” “designed to,” “adapted to,” “made to,” or “capable of.” The expression “configured to” does not necessarily mean “specifically designed to” in a hardware sense. Instead, under some circumstances, “a device configured to” may indicate that such a device can perform an action along with another device or part. For example, the expression “a processor configured to perform A, B, and C” may indicate an exclusive processor (e.g., an embedded processor) to perform the corresponding action, or a generic-purpose processor (e.g., a central processor (CPU) or application processor (AP)) that can perform the corresponding actions by executing one or more software programs stored in the memory device.

An electronic apparatus (including a different electronic apparatus, first electronic apparatus, a second electronic apparatus, and a third electronic apparatus) in accordance with embodiments of the disclosure may include any one or any combination of, for example, smartphones, tablet PCs, mobile phones, video telephones, electronic book readers, desktop PCs, laptop PCs, netbook computers, workstations, servers, a PDA, a portable multimedia player (PMP), an MP3 player, a medical device, a camera, or a wearable device. A wearable device may include any one or any combination of the accessory type (e.g., as a watch, a ring, a bracelet, a bracelet, a necklace, a pair of glasses, a contact lens or a head-mounted-device (HMD)); a fabric or a garment embedded type (e.g., a skin pad or a tattoo); or a bio-implantable circuit.

In some embodiments, the electronic apparatus may be a home appliance. For example, the home appliance may include at least one of a television, a digital video disk (DVD) player, audio, refrigerator, cleaner, ovens, microwaves, washing machines, air purifiers, set top boxes, home automation control panels, security control panels, media box (e.g., Samsung HomeSync™, Apple TV™, or Google TV™), game consoles (e.g., Xbox™, PlayStation™), electronic dictionary, electronic key, camcorder, or electronic frame.

In other embodiments, the electronic apparatus may include any one or any combination of a variety of medical devices (e.g., various portable medical measurement devices such as a blood glucose meter, a heart rate meter, a blood pressure meter, or a temperature measuring device), magnetic resonance angiography (MRA), magnetic resonance imaging (MRI), computed tomography (CT), or ultrasonic wave device, etc.), navigation system, global navigation satellite system (GNSS), event data recorder (EDR), flight data recorder (FDR), automotive infotainment devices, marine electronic equipment (e.g., marine navigation devices, gyro compasses, etc.), avionics, security devices, car head units, industrial or domestic robots, drone, ATMs, points of sale of stores, or IoT devices (e.g., light bulbs, sensors, sprinkler devices, fire alarms, thermostats, street lights, toasters, exercise equipment, hot water tanks, heater, boiler, etc.).

According to yet another embodiment, an electronic apparatus may be a furniture or a portion of a building/structure, an electronic board, an electronic signature receiving device, a projector, or various metrology equipment (for example: water, electricity, gas, or radio wave metrology equipment, etc.). In various embodiments, the electronic apparatus may be a combination of one or more of the various devices described above. In an embodiment, an electronic apparatus may be a flexible electronic apparatus. Furthermore, an electronic apparatus according to an embodiment is not limited to the devices described above, and may include a new electronic apparatus according to technology development.

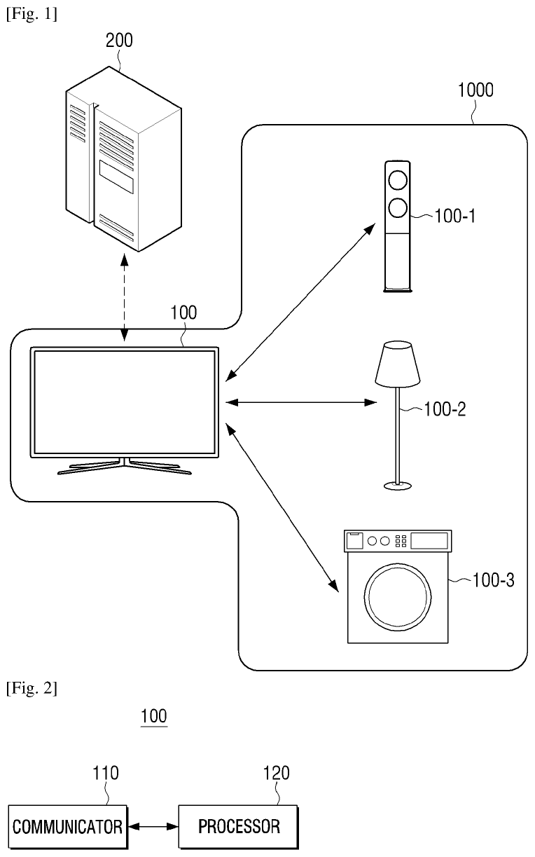

FIG. 1 is a view of the IoT environment 1000, according to an embodiment.

Referring to FIG. 1, the IoT system 1000 may include a plurality of electronic apparatuses forming the IoT environment.

Here, the IoT environment may mean a state in which a plurality of electronic apparatuses is connected by wired/wireless communication network so that one of the plurality of electronic apparatuses forming the IoT environment performs communication with a different electronic apparatus and share obtained information, provides a user with information, or controls a different electronic apparatus according to a user command.

The plurality of electronic apparatuses may include the electronic apparatus 100, a first electronic apparatus 100-1, a second electronic apparatus 100-2, and a third electronic apparatus 100-3, as illustrated in FIG. 1. This is merely exemplary, and the number of the electronic devise may be changed in a diverse manner for implementation.

In the disclosure, the first electronic apparatus 100-1, the second electronic apparatus 100-2, and the third electronic apparatus 100-3 are distinguished from each other merely for convenience of description. Unless otherwise specified, the description of the electronic apparatus 100 may be applied in the same manner. Accordingly, the first electronic apparatus 100-1, the second electronic apparatus 100-2, and the third electronic apparatus 100-3 have the same configuration or the same function or operation as the electronic apparatus 100 unless otherwise specified. Hereinafter, the electronic apparatus 100 among the plurality of electronic apparatuses will be described in order to avoid redundant descriptions.

The electronic apparatus 100 may be an electronic apparatus among the plurality of electronic apparatuses forming the IoT environment.

The electronic apparatus 100 is an electronic apparatus including a communication function and may communicate with a different electronic apparatus forming the IoT environment using communication methods such as Wi-Fi, ZigBee, Z-wave, Bluetooth, near field communication (NFC), or the like, or an external electronic apparatus, or the like.

For example, the electronic apparatus 100 may communicate with a different electronic apparatus via router which functions as a bridge such as an access point (AP, now shown) or connection such as device-to-device (D2D) or peer-to-peer (P2P), or the like, but the embodiment is not limited thereto.

Meanwhile, the electronic apparatus 100 may perform a sub-service related to a service with a different electronic apparatus among a plurality of electronic apparatuses forming the IoT environment, respectively, and provide a user with a service in which the plurality of sub-services is linked. That is, one service may be provided by interworking (or linking) a sub-service performed by the electronic apparatus 100 and a sub-service performed by a different electronic apparatus.

At this time, the service may be understood as a function/operation performed by a plurality of electronic apparatuses that interwork with each other.

Here, the sub-service is a service of a lower concept related to (or subordinate to) a service and may mean a function/operation performed by each of the plurality of electronic apparatuses. For example, a sub-service maybe an operation such as “adjusting screen/light brightness,” “adjusting fan rotation speed,” “transmitting notification information to a different electronic apparatus,” “printing notification information,” “providing web search results,” “performing a laundry function,” “performing a function to control indoor temperature,” or the like.

In one embodiment, a sleeping service may be provided to a user, as sub-services performed by each of the plurality of electronic apparatuses forming the IoT environment are associated with each other. For example, among a plurality of electronic apparatuses forming the IoT environment, a TV (or lighting, or the like) may perform a sub-service to turn off power, a smart curtain may perform a sub-service of drawing the curtains, an air cleaner may provide a sub-service to reduce the rotational speed of a fan, or the like.

According to another embodiment, from among a plurality of electronic apparatuses forming an IoT environment, a washing machine may perform a sub-service of transmitting notification information notifying the completion of washing to a TV, and the TV may perform a sub-service of displaying the received notification information on the screen, thereby providing a user with a notification service informing that washing is completed.

As described above, the electronic apparatus 100 may provide a user with a service related to a plurality of sub-services by performing a plurality of sub-services which are in association with each other with at least one electronic apparatus among a plurality of electronic apparatuses forming the IoT environment.

The electronic apparatus 100 may perform a sub-service through an application (or app). That is, an application may be required to perform a sub-service by the electronic apparatus 100. The application may then be understood as a term covering a programmed (or coded) computer language/code/program/application/software or the like that allow the electronic apparatus to perform a sub-service.

For this purpose, the electronic apparatus 100 and a server 200 may transceiver various information or data by performing wired/wireless communication according to various communication methods.

The server 200 may include a server providing an application such as an application store (for example: a galaxy app #1, a play store #1, an app store 1). According to an embodiment, the server 200 may include a server that provides an application, such as the internet. According to one embodiment, when a request to search for an application of the electronic apparatus 100 is received, the server 200 may search for a preregistered (or pre-stored) application in the server 200, in response to an application search request of the electronic apparatus 100, and send the searched application to the electronic apparatus 100.

The server 200 may include a cloud server for providing synchronization. According to an embodiment, the cloud server may include an account server and a service server. The account server may perform user authentication. The service server may manage information on a plurality of electronic apparatuses that may form the IoT environment, information required to perform a service or a sub-service, or the like, and perform a function of message notification, or the like.

The sever 200 may be implemented as an integrated server including the application store and the cloud server, but the server 200 may be implemented as individual servers.

In order to perform a sub-service in association with a different electronic apparatus among a plurality of electronic apparatuses forming the IoT environment, the electronic apparatus 100 may identify a first electronic apparatus 100-1 capable of performing a first sub-service among a plurality of sub-services for providing a service, receive, from the server 200, information on a first application that is required for the first electronic apparatus 100-1 to perform a first sub-service, and transmit, to the first electronic apparatus 100-1, information on the received first application.

Accordingly, when information on the first application may not be received from the server 200, the first electronic apparatus 100-1 may receive, from the electronic apparatus 100, information on the first application, and perform the first sub-service through the received first application.

The electronic apparatus 100 according to an embodiment may automatically search an application that is required to perform the sub-service by a different electronic apparatus from among a plurality of electronic apparatuses forming the IoT environment and transmit the application to a different electronic apparatus. Accordingly, a user may conveniently install or execute an application required by each of a plurality of electronic apparatuses, even if a user command is not input or manipulated for each of the plurality of electronic apparatuses.

Hereinbelow, the electronic apparatus according to an embodiment will be described in greater detail with reference to a drawing.

FIG. 2 is a block diagram of an electronic apparatus, according to an embodiment.

Referring to FIG. 2, the electronic apparatus 100 may include a communicator 110 and a processor 120.

The communicator 110 may transceive various types of information by communicating with a plurality of electronic apparatuses (not shown) that are different from the electronic apparatus 100 and various types of external devices such as the server 200. The communicator 110 may be controlled by the processor 120.

For this purpose, the communicator 110 may include a Bluetooth chip performing wireless communication according to the Bluetooth communication specification, a Wi-Fi chip performing wireless communication according to the Wi-Fi communication specification, radio-frequency identification (RFID), wireless local area network (WLAN), global system for mobile communication (GSM), a wireless communication chip performing wireless communication specification according to communication specification such as 3^{rd} generation (3G), 4th generation (4G, including LTE), 5^{th} generation (5G), or the like, the NFC chip, or the like.

The processor 120 may control overall operations of the electronic apparatus 100.

The processor 120 may control a plurality of hardware or software elements connected to the processor 120 by driving, for example, an operating system, an application, and perform various data processing and calculation. The processor may include any one of a central processing unit (CPU), graphics processing unit (GPU), or an accelerated processing unit (APU) or may be implemented with the combination thereof.

The processor 120 may identify the first electronic apparatus 100-1 capable of performing a first sub-service among a plurality of sub-services for providing a service, from among a plurality of electronic apparatuses forming the IoT environment, control the communicator 110 to transmit information on the first application for performing the first sub-service received from the server 200 to the first electronic apparatus 100-1, receive, from the server 200, the second application to perform the second sub-service which the electronic apparatus 100 may perform among the plurality of sub-services, through the communicator 110, and perform the second sub-service through the received second application, in order to provide a service in association with the first electronic apparatus 100-1 performing the first sub-service through the first application.

To be specific, the processor 120 may identify the first electronic apparatus 100-1, among the plurality of electronic apparatuses forming the IoT environment, capable of performing the first sub-service among a plurality of sub-services for providing a service.

The processor 120 may identify the first electronic apparatus 100-1 capable of performing the first sub-service among the plurality of electronic apparatuses based on information (or discovery information) for the plurality of electronic apparatuses received from the plurality of electronic apparatuses through the communicator 110.

For this purpose, the processor 120 may receive, from each of the plurality of electronic apparatuses forming the IoT environment, information on a plurality of electronic apparatuses through the communicator 110. The information on the plurality of electronic apparatuses (or discovery information) may include a unique identifier assigned to the plurality of electronic apparatuses, hardware configuration, a function which the plurality of electronic apparatuses may perform, a list of applications installed in the plurality of electronic apparatuses, a firmware/OS version, or the like.

The processor 120 may identify the first electronic apparatus 100-1 capable of performing the first sub-service among a plurality of electronic apparatuses based on the received information on the plurality of electronic apparatuses. The processor 120 may receive, from the server 200, information required to perform the first sub-service through the communicator 110, or access information required to perform the first sub-service prestored in the electronic apparatus 100. Here, the server 200 may include the aforementioned cloud server. The information required to perform the sub-service may include at least one of a unique identifier assigned to the electronic apparatus, hardware configuration, function, information on an application, and firmware/OS version.

For example, the processor 120 may identify that the electronic apparatus that satisfies all the information requested to perform the first sub-service, from among the plurality of electronic apparatuses, as the first electronic apparatus 100-1 capable of performing the first sub-service, by comparing the information (example: washing function or unique identifier, or the like) requested to perform the first sub-service (example: transmitting a notification information when washing operation is completed) received from the server 200 and the information on the plurality of electronic apparatuses received from the plurality of electronic apparatuses.

In this case, the processor 120 may receive, from the server 200, an identification value for an application to perform a sub-service. The identification value for the application may be used in searching by the server 200 a specific application among a plurality of applications. For example, the server 200 may search an application that matches the identification value among a plurality of applications prestored (or registered) in the server 200.

The processor 120 may control the communicator 110 to transmit, to the first electronic apparatus 100-1, information on the first application for performing the first sub-service received from the server 200.

Here, the information on the first application may include at least one of a package for installing the first application or a uniform resource locator (URL) for receiving a package from the server 200. In this case, the package may include at least one of a computer language/code/program that is programmed (or coded) to install the first application or a computer language/code/program capable of running the first application without a separate installation. The URL for receiving a package may refer to an address for receiving a package by accessing a package for the first application prestored in the server 200 through a network.

Specifically, when it is identified that the first electronic apparatus 100-1, among a plurality of electronic apparatuses, capable of performing the first sub-service existing, the processor 120 may control the communicator 110 to transmit a signal requesting to transmit, to the server 200, information for the first application to perform the first sub-service.

The server 200 may search for a first application among a plurality of applications registered in the server 200 based on the received request signal, and transmit information on the searched first application to the electronic apparatus 100. The server 200 may include the above-described application store. When the information on the first application for performing the first sub-service is received from the server 200 through the communicator 110, the processor 120 may control the communicator 110 to transmit the received information on the first application to the first electronic apparatus 100-1. In this case, when the first electronic apparatus 100-1 may not communicate with the server 200, the first electronic apparatus 100-1 may install the first application using a package for installing the first application received from the electronic apparatus 100, and when the first electronic apparatus 100-1 may communicate with the server 200, the first electronic apparatus 100-1 may receive, from the server 200, the first application through the URL received from the electronic apparatus 100 and install the first application.

The processor 120 may receive, from the server 200, a second application for performing the second sub-service which the electronic apparatus 100 may perform, among the plurality of sub-services, through the communicator 110.

For this purpose, the processor 120 may identify the second sub-service that the electronic apparatus 100 may perform among the plurality of sub-services based on the information on the electronic apparatus 100 pre-stored in the electronic apparatus 100. In this case, the information on the electronic apparatus 100 may include a unique identifier assigned to the electronic apparatus 100, a hardware configuration, a function that the electronic apparatus 100 may perform, a list of applications installed on the electronic apparatus 100, a firmware/OS version, or the like.

For example, the processor 120 may identify the second sub-service (example: upon receiving notification information, display the notification information on a screen) which the electronic apparatus 100 may perform, among a plurality of sub-services, by comparing the information required to perform a plurality of sub-services and information on the electronic apparatus 100.

The processor 120 may control the communicator 110 to transmit, to the server 200, a signal requesting to transmit the second application to perform the second sub-service. The server 200 may search for the second application according to the application request signal in the same manner as the aforementioned description and transmit to the electronic apparatus 100.

The processor 120 may receive, from the server 200, the second application to perform the second sub-service through the communicator 110. The processor 120 may perform the second sub-service through the received second application, in order to provide a service in association with the first electronic apparatus 100-1 performing the first sub-service based on the information on the first application.

Specifically, the processor 120 may perform the second sub-service in association with the first sub-service performed by the first electronic apparatus 100-1 by installing the received second application and executing the installed second application. The first electronic apparatus 100-1 may install the first application based on the information on the first application and execute the installed first application to perform the first sub-service in association with the second sub-service. That is, the processor 120 may communicate with the first electronic apparatus 100-1 to perform a second sub-service in association with the first sub-service.

This is merely exemplary, and the processor 120 and the first electronic apparatus 100-1 may perform the first sub-service and the second sub-service in association with the first sub-service through the different electronic apparatus by performing communication with the different electronic apparatus, respectively, among a plurality of electronic apparatuses forming the IoT environment.

In the embodiment described above, it has been described that the electronic apparatus 100 identifies the first electronic apparatus 100-1 capable of performing the first sub-service, among the plurality of electronic apparatuses, but unlike the foregoing, it is also possible that the server 200 identifies the sub-service which the electronic apparatus 100 may perform and transmit information on an application corresponding thereto.

Specifically, upon receiving, from a plurality of electronic apparatuses forming the IoT environment, information (or discovery information) on a plurality of electronic apparatuses, the processor 120 may control the communicator 110 to transmit the received information to the server 200.

In this case, the server 200 may identify a sub-service which the first electronic apparatus 100-1, among the plurality of electronic apparatuses, may perform and the sub-service which the electronic apparatus 100 may perform, based on the received information on the plurality of electronic apparatuses.

For example, assuming that a sub-service that can be performed by the first electronic apparatus 100-1 among a plurality of electronic apparatuses forming the IoT environment is a first sub-service and the sub-service that the electronic apparatus 100 can perform is a second sub-service, the server 200 may compare the received information on the plurality of electronic apparatuses with information required to perform the plurality of sub-services, and identify such that the first electronic apparatus 100-1 may perform the first sub-service, and that the electronic apparatus 100 may perform the second sub-service. However, this is merely exemplary, and the number of electronic apparatuses forming the IoT environment may be variously modified.

The server 200, based on the received information on the plurality of electronic apparatuses, may transmit, to the electronic apparatus 100, information on the first application corresponding to the first sub-service, a distribution instruction that is set to transmit information on the first application to the first electronic apparatus 100-1, and information on the second application corresponding to the second sub-service.

The processor 120 may control the communicator 110 to transmit information on the first application to the first electronic apparatus 100-1 based on the received distribution instruction. In this case, the processor 120 may perform the second sub-service based on the information on the received second application, in order to provide a service in association with the first electronic apparatus 100-1 which performs the first sub-service based on the information on the first application.

Accordingly, the electronic apparatus 100 forming the IoT environment and the first electronic apparatus may provide a user with a service in which the first sub-service and the second sub-service are in association with each other.

For example, assuming that the electronic apparatus 100 is a TV and the first electronic apparatus 100-1 is a washing machine, a user may be provided with a notification service in which the first sub-service is in association with the second sub-service, by performing the first sub-service by the first electronic apparatus 100-1 to transmit the notification information notifying that washing is completed to the electronic apparatus 100 through the first application and performing the second sub-service by the processor 120 of the electronic apparatus 100 to display the received notification on the screen upon receiving the notification information through the second application.

The processor 120 may perform the second sub-service by installing the received second application in the electronic apparatus 100 and running the installed second application.

For this purpose, the processor 120 may install the received second application in a storage space of a memory (not shown) included in the electronic apparatus 100. In this case, the received second application may include at least one of a computer language/code/program programmed (or coded) to install the second application or a computer language/code/program capable of executing the second application without a separate installation.

The processor 120 may perform the second sub-service by running the installed second application (that is, by processing at least one instruction included in the second application).

The memory is accessed by the processor 120, and reading/writing/modifying/deleting/updating of data may be performed by the processor 120. The memory may include an internal memory and an external memory. The internal memory may include at least one of volatile memory (example: dynamic RAM (DRAM), static RAM (SRAM), synchronous dynamic RAM (SDRAM), or the like), non-volatile memory (example: one time programmable ROM (OTPROM), programmable ROM (PROM), erasable and programmable ROM (EPROM), electrically erasable and programmable ROM (EEPROM), mask ROM, flash ROM, flash memory (example: nonconjunction (NAND) flash or nondisjunction (NOR) flash, or the like), hard drive, or solid state drive (SSD)). The external memory may include a flash drive, compact flash (CF), secure digital (SD), micro secure digital (micro-SD), mini secure digital (mini-SD), extreme digital (xD), multi-media card (MMC), a memory stick, or the like. The memory may be included in the processor 120 or may be implemented as a storage device existing outside the processor 120 separately.

In one embodiment, it is assumed that there is an alternative electronic apparatus 100′ which is capable of performing a second sub-service, other than the electronic apparatus 100. The alternative electronic apparatus may include the configurations of the electronic apparatus 100.

The processor 120 may identify whether there is an alternative electronic apparatus 100′ capable of performing the second sub-service, among the plurality of electronic apparatuses, and when there is an alternative electronic apparatus 100′ capable of performing the second sub-service, the processor 120 may control the communicator 110 to transmit the received second application to the alternative electronic apparatus 100′.

Specifically, the processor 120 may receive, from each of the plurality of electronic apparatuses forming the IoT environment, information on the plurality of electronic apparatuses.

The processor 120 may identify whether there is the alternative electronic apparatus 100′ capable of performing the second sub-service, among the plurality of electronic apparatuses, based on the received information on the plurality of electronic apparatuses.

For example, the processor 120 may identify an electronic apparatus, from among the plurality of electronic apparatuses, which satisfies all the information requested to perform the second sub-service as the alternative electronic apparatus 100′ capable of performing the second sub-service, by comparing information (example: a display function or unique identifier, or the like) requested to perform the second sub-service (example: displaying a notification on a display) and information on the plurality of electronic apparatuses received from the plurality of electronic apparatuses.

When there is the alternative electronic apparatus 100′ capable of performing the second sub-service, the processor 120 may control the communicator 110 to transmit the second application received from the server 200 to the alternative electronic apparatus 100′.

In this case, the alternative electronic apparatus 100′ may perform the second sub-service based on the information on the second application received from the electronic apparatus 100, in order to provide a service in association with the first electronic apparatus 100-1 which performs the first sub-service through the first application. Here, the information on the second application may include at least one of a package for installing the second application or the URL for receiving the package from the server 200.

To be specific, when the alternative electronic apparatus 100′ may not communicate with the server 200, the alternative electronic apparatus 100′ may install the second application using the package for installing the second application that is received from the electronic apparatus 100, and when the alternative electronic apparatus 100′ may communicate with the server 200, may install the second application by receiving the second application from the server 200 through the URL received from the electronic apparatus 100.

In addition, the alternative electronic apparatus 100′ may perform the second sub-service in association with the first sub-service through the installed second application, and the first electronic apparatus 100-1 may perform the installed first application in association with the second sub-service through the installed first application. Accordingly, a service in which the first sub-service is in association with the second sub-service may be provided.

When the alternative electronic apparatus 100′ performs the second sub-service, the processor 120 may control not to perform the second sub-service through the second application.

According to an embodiment as described above, when the electronic apparatus 100 capable of performing the second sub-service leaves from the IoT environment (example: when the electronic apparatus 100 is out of a distance capable of communicating with at least one electronic apparatus among a plurality of electronic apparatuses forming the IoT environment, when the electronic apparatus 100 is not able to operate normally such as being damaged or terminated, when the electronic apparatus 100 is turned off according to a user command, or the like), the alternative electronic apparatus 100′ may perform the second sub-service, and a service may be provided by interlocking the first electronic apparatus 100-1 and the first sub-service.

In addition, if there is an alternative electronic apparatus 100′ that has better performance (example: operation speed, communication speed, or the like) than the electronic apparatus 100, or has an extended range of functions or operations than the electronic apparatus 100, the alternative electronic apparatus 100′ may perform the second sub-service in replacement of the electronic apparatus 100. That is, the alternative electronic apparatus 100′ may provide the service in association with at least one electronic apparatus among the plurality of electronic apparatuses forming the IoT environment by providing the service in association with the first sub-service with the first electronic apparatus 100-1, in replacement of the electronic apparatus 100, or performing a sub-service in an extended range (that is, the range which the electronic apparatus 100 may not perform) than the sub-service that can be performed by the electronic apparatus 100.

The electronic apparatus 100 may distribute the second application even when the electronic apparatus 100 or the alternative electronic apparatus 100′ may not communicate with the server 200, by transmitting information on the second application installed in the electronic apparatus 100 or the second application stored in the electronic apparatus 100 to the alternative electronic apparatus 100′.

As an embodiment, upon receiving an instruction to request the third application for performing the third sub-service from the second electronic apparatus 100-2 among the plurality of electronic apparatuses, the processor 120 may receive information, from the server 200, about the third application through the communicator 110, and control the communicator 110 to transmit the received information on the third application to the second electronic apparatus 100-2 which transmitted the instruction.

The plurality of sub-services may include a third sub-service, and a service may be provided to a user by performing the third sub-service in association with a different service from among the plurality of sub-services by a part or all of the plurality of electronic apparatuses forming the IoT environment.

Specifically, when the processor 120 receives an instruction for requesting the third application for performing the third sub-service from the second electronic apparatus 100-2, among the plurality of electronic apparatuses, the processor 120 may control the communicator 110 to transmit, to the server 200, a signal for requesting transmission of information on the third application for performing the third sub-service. The information on the third application may include at least one of a package for installing the third application or a URL for receiving the package from the server 200.

The server 200, based on the received request signal, may search for a third application among the plurality of applications registered in the server 200, and transmit the searched information on the third application to the electronic apparatus 100.

When information on the third application is received from the server 200, the processor 120 may control the communicator 110 to transmit received information on the third application to the second electronic apparatus 100-2 which transmitted the instruction.

In this case, the second electronic apparatus 100-2 may perform the third sub-service based on the information on the third application received from the electronic apparatus 100, in order to provide a service in association with a different electronic apparatus among the plurality of electronic apparatuses.

Specifically, when the second electronic apparatus 100-2 may not communicate with the server 200, the second electronic apparatus 100-2 may install the third application using the package for installing the third application received from the electronic apparatus 100. If the second electronic apparatus 100-2 may communicate with the server 200, the third application may be received from the server 200 through the URL received from the electronic apparatus 100 and the third application may be installed.

The processor 120 may execute the installed second application and perform the second sub-service in association with the third sub-service, and the second electronic apparatus 100-2 may execute the installed third application and perform the third sub-service in association with the second sub-service.

Accordingly, the electronic apparatus 100 and the second electronic apparatus 100-2 forming the IoT environment may provide a user with a service in which the second sub-service and the third sub-service are associated with each other.

As an embodiment, it is assumed that the electronic apparatus 100 performs the fourth sub-service using information received from the third electronic apparatus 100-3 forming the IoT environment.

The processor 120 may receive, from the server 200, a fourth application corresponding to a fourth sub-service for providing a service through the communicator 110, and perform the fourth sub-service through the received fourth application, in order to provide a service in association with the third electronic apparatus 100-3 that obtains information for the fourth sub-service, among the plurality of electronic apparatuses. In this case, the fourth sub-service may include a sub-service requiring the information received from the third electronic apparatus 100-3. For example, as an embodiment, the fourth sub-service may be a sub-service such as “adjusting the blowing intensity” of the air conditioner requiring the temperature information received from the temperature sensor that is the third electronic apparatus 100-3.

The processor 120 may control the communicator 110 to transmit, to the server 200, a signal requesting to transmit the fourth application corresponding to the fourth sub-service, in order to provide a service.

The server 200 may search the fourth application, among the plurality of applications registered in the server 200, based on the received request signal and transmit the searched fourth application to the electronic apparatus 100.

The processor 120 may receive, from the server 200, the fourth application through the communicator 110.

The processor 120 may perform the fourth sub-service through the received fourth application, in order to provide a service in association with the third electronic apparatus 100-3 which obtains the information for the fourth sub-service, among the plurality of electronic apparatuses.

The processor 120 may receive, from the third electronic apparatus 100-3, information on a fourth sub-service that is obtained by the third electronic apparatus 100-3, and perform the fourth sub-service through the received fourth application based on the received information for the fourth sub-service.

Specifically, the processor 120 may receive, from the third electronic apparatus 100-3, information for the fourth sub-service through the communicator 110, in order to perform the fourth sub-service, and perform the fourth sub-service through the fourth application based on the received information.

Accordingly, the electronic apparatus 100 may provide a user with a service in association with the third electronic apparatus 100-3 by performing the fourth sub-service based on the information obtained by the third electronic apparatus 100-3 among the plurality of electronic apparatuses forming the IoT environment.

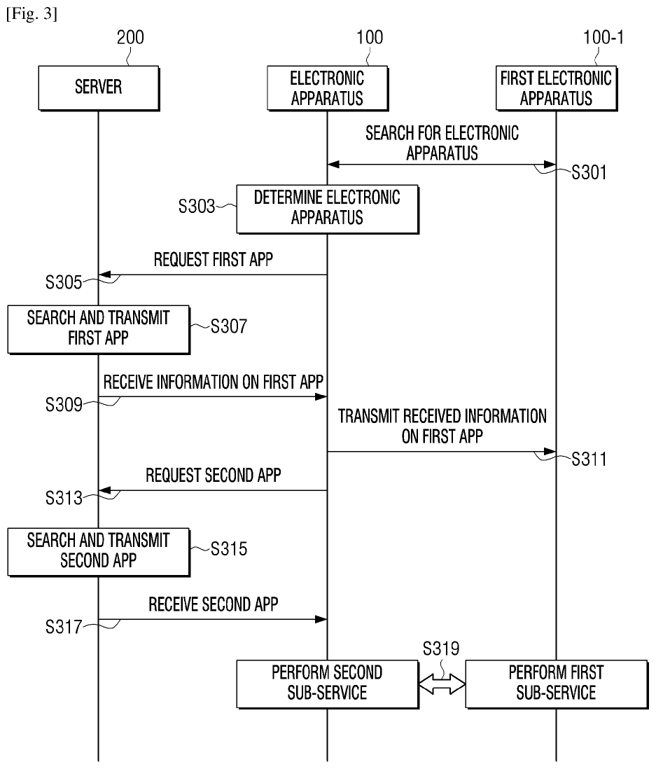

Hereinbelow, various embodiments will be described with reference to FIGS. 3 to 10. FIGS. 3 to 6 are views to describe a sequence of performing a sub-service by the electronic apparatus 100 according to an embodiment, and FIGS. 7 to 10 are views to describe the electronic apparatus 100 according to an embodiment. The description overlapping with the description above will be described in brief. Hereinbelow, various embodiments will be described with reference to FIGS. 3 to 10.

Referring to FIGS. 3 and 7, it is assumed that the electronic apparatus 100 may perform the second sub-service, and the first electronic apparatus 100-1 may perform the first sub-service. It is assumed that the first sub-service is “transmitting notification information to another electronic apparatus” and the second sub-service is “outputting received notification information.”

The electronic apparatus 100 may search a plurality of electronic apparatuses forming the IoT environment in operation S301. The electronic apparatus 100 may transmit a signal for searching of the plurality of electronic apparatuses forming the IoT environment using various types of network protocols, and receive information on the plurality of electronic apparatuses from the plurality of electronic apparatuses, in response thereto.

The electronic apparatus 100 may identify the first electronic apparatus 100-1 capable of performing the first sub-service among the plurality of electronic apparatuses based on the information on the plurality of electronic apparatuses received in the search process in operation S303.

When it is identified that there is the first electronic apparatus 100-1 capable of performing the first sub-service, among the plurality of electronic apparatuses, the electronic apparatus 100 may transmit, to the server 200, a signal requesting to transmit information on the first application (or first app) for performing the first sub-service in operation S305.

Upon receiving a signal requesting to search for and transmit the first application in operation S305, the server 200 may search for the first application among the plurality of applications registered in the server 200, and transmit information on the searched first application to the electronic apparatus 100 in operation S307.

Upon receiving, from the server 200, information on the first application to perform the first sub-service in operation S309, the electronic apparatus 100 may transmit, to the first electronic apparatus 100-1, received information on the first application in operation S311.

The electronic apparatus may transmit, to the server 200, a signal requesting to transmit the second application (or second app) for performing the second sub-service in operation S313.

Upon receiving the signal requesting to search for and transmit the second application in operation S313, the server 200 may search for the second application among the plurality of applications registered in the server 200 and transmit the searched second application to the electronic apparatus 100 in operation S315.

In this case, the electronic apparatus 100 may receive, from the server 200, the second application to perform the second sub-service in operation S317.

In addition, the electronic apparatus 100 may perform the second sub-service through the second application received in association with the first electronic apparatus 100-1 performing the first sub-service based on the information on the first application, and provide the notification service by interlocking the first sub-service (transmitting notification information to the electronic apparatus 100) and the second sub-service (outputting the received notification information) in operation S319.

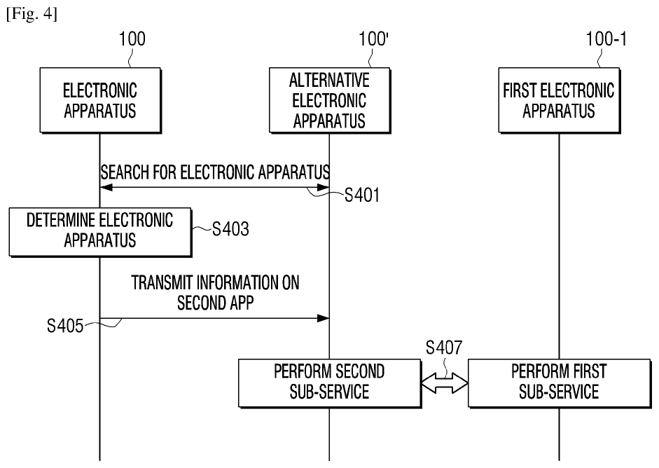

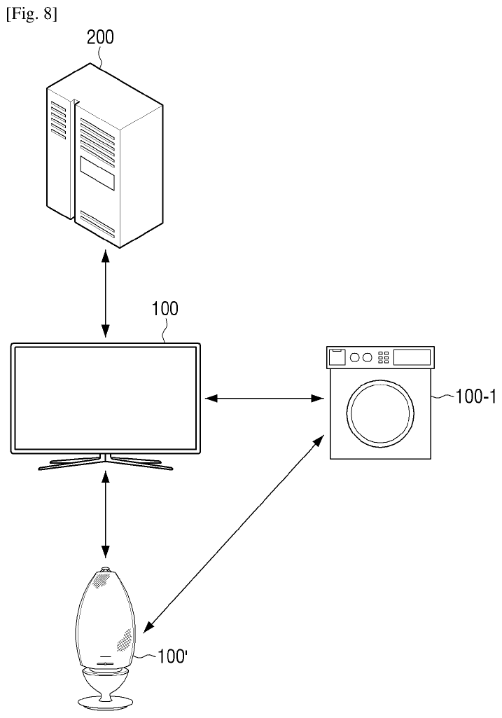

Referring to FIGS. 4 and 8, it is assumed that there is the alternative electronic apparatus 100′ capable of performing the second sub-service other than the electronic apparatus 100 capable of performing the second sub-service, as an embodiment.

The electronic apparatus 100 may search for the plurality of electronic apparatuses forming the IoT environment in operation S401, and identify the alternative electronic apparatus 100′ capable of performing the second sub-service, among the plurality of searched electronic apparatuses in operation S403.

When there is the alternative electronic apparatus 100′ capable of performing the second sub-service, the electronic apparatus 100 may transmit the received second application to the alternative electronic apparatus 100′ in operation S405.

In this case, the alternative electronic apparatus 100′ may receive, from the electronic apparatus 100, the second application in operation S405, and provide a service by performing the second sub-service through the second application that is received from the electronic apparatus 100 in association with the first electronic apparatus 100-1 performing the first sub-service through the first application in operation S407.

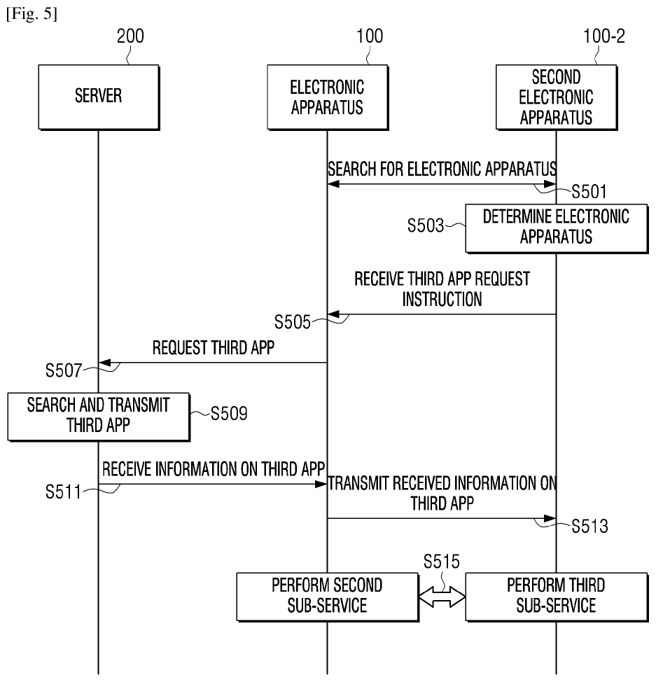

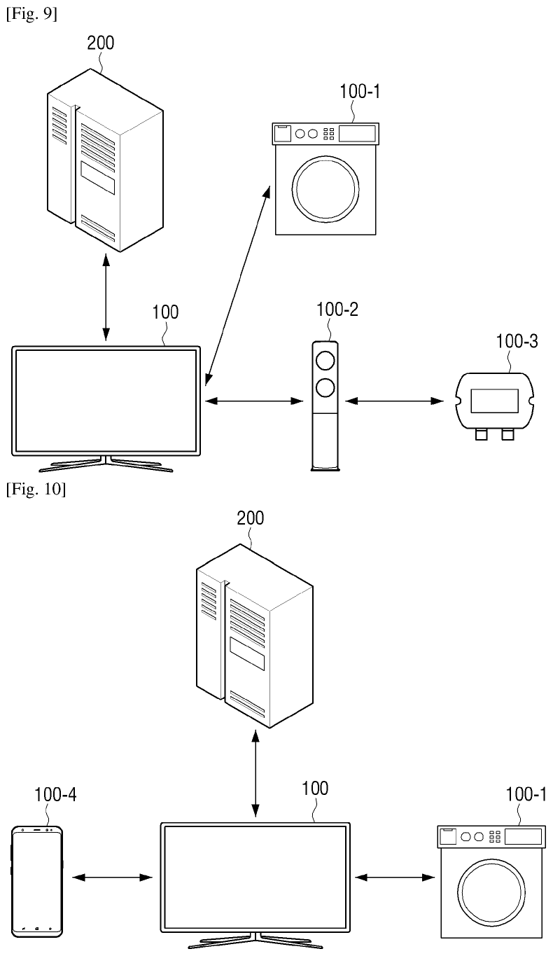

Referring to FIGS. 5 and 9, it is assumed as an embodiment that there are the electronic apparatus 100 capable of communicating with the server 200 in the IoT environment and the second electronic apparatus 100-2 not capable of communicating with the server 200.

The second electronic apparatus 100-2 may search for a plurality of electronic apparatuses forming the IoT environment in operation S501 and, based on the information on the plurality of electronic apparatuses received in the search process, identify the electronic apparatus 100 capable of communicating with the server 200, among the plurality of electronic apparatuses in operation S503. When it is identified that the electronic apparatus 100 capable of communicating with the server 200 exists, the second electronic apparatus 100-2 may transmit, to the electronic apparatus 100, an instruction to request a third application (or a third app) for performing the third sub-service in operation S505.

Upon receiving an instruction requesting the third application to perform the third sub-service from the second electronic apparatus 100-2 among the plurality of electronic apparatuses forming the IoT environment in operation S505, the electronic apparatus 100 may transmit, to the server 200, a signal requesting to transmit the third application in operation S507.

Upon receiving a signal requesting to transmit the third application in operation S507, the server 200 may search for the third application among the plurality of applications registered in the server 200 and transmit the searched third application to the electronic apparatus 100 in operation S509.

Upon receiving the third application from the server 200 in operation S511, the electronic apparatus 100 may transmit the received third application to the second electronic apparatus 100-2 which transmitted the instruction in operation S513.

The second electronic apparatus 100-2 may receive the third application from the electronic apparatus 100 in operation S513, and provide a service by performing the third sub-service through the third application received from the electronic apparatus 100 in association with the electronic apparatus 100 performing the second sub-service through the second application in operation S515.

However, this is merely an embodiment, and the second electronic apparatus 100-2 may perform the sub-service to provide the service in association with the third electronic apparatus 100-3 as illustrated in FIG. 9. That is, the second electronic apparatus 100-2 may provide a service by performing the third sub-service in association with another electronic apparatus 100-3 that performs a fifth sub-service among the plurality of electronic apparatuses forming the IoT environment.

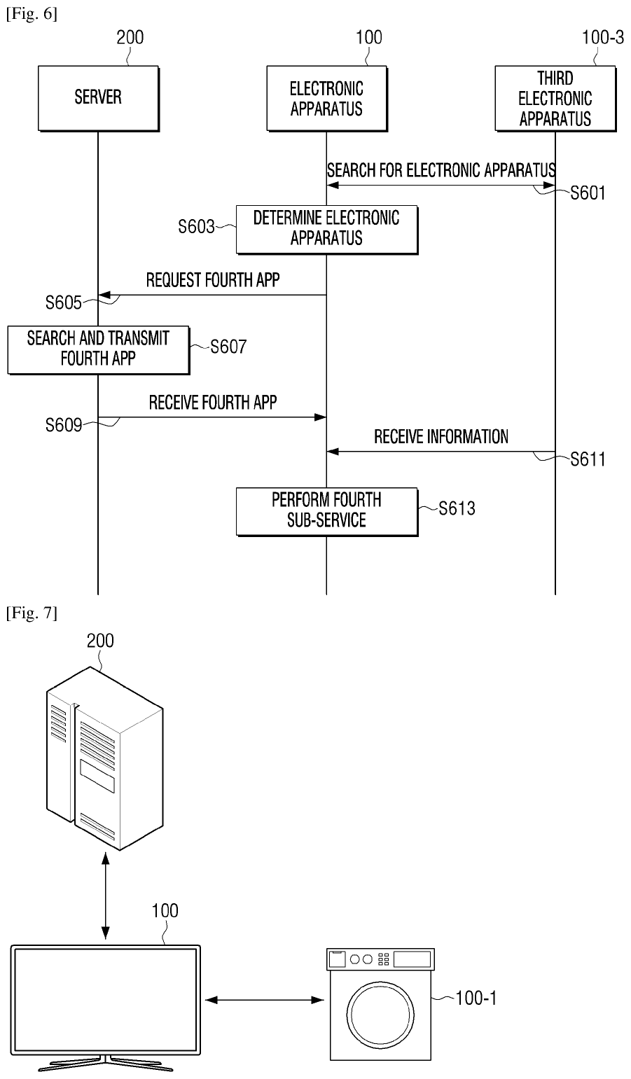

Referring to FIG. 6, it is assumed as an embodiment that the electronic apparatus 100 performs the fourth sub-service to use the information received from the third electronic apparatus 100-3 forming the IoT environment.

The electronic apparatus 100 may search for a plurality of electronic apparatuses forming the IoT environment in operation S601, and the electronic apparatus 100 identify the third electronic apparatus 100-3 capable of obtaining the information, among the plurality of electronic apparatuses, based on the information on the plurality of electronic apparatuses received in the search process in operation S603. The third electronic apparatus 100-3 may refer to an electronic apparatus that may obtain about temperature, humidity, illuminance, distance, or the like, such as a sensor.

If it is identified that the third electronic apparatus 100-3 exists among the plurality of electronic apparatuses, the electronic apparatus 100 may transmit, to the server 200, a signal requesting to transmit the fourth application (or fourth app) for performing the fourth sub-service using the information received from the third electronic apparatus 100-3 in operation S605.

In this case, the server 200, upon receiving a signal requesting to transmit the fourth application, may search for the fourth application among the plurality of applications registered in the server and transmit the searched fourth application to the electronic apparatus 100 in operation S607.

The electronic apparatus 100 may receive the fourth application from the server 200 in operation S609, receive the information obtained by the third electronic apparatus 100-3 from the third electronic apparatus 100-3 in operation S611, and perform the fourth sub-service through the fourth application in operation S613. The electronic apparatus 100 may perform the fourth sub-service by interworking the sub-service with another electronic apparatus among the plurality of electronic apparatuses in the same manner as the embodiment as described above.

Referring to FIG. 10, it is assumed that the IoT environment may include the fourth electronic apparatus 100-4 as an embodiment, and the fourth electronic apparatus 100-4 may register, control, or manage the plurality of electronic apparatuses forming the IoT environment through an application. Meanwhile, although FIG. 10 illustrates the fourth electronic apparatus 100-4 as a smart phone, this is only an embodiment and the fourth electronic apparatus 100-4 may be implemented as various electronic apparatuses such as a smart TV, an artificial intelligence speaker, a gateway, or the like.

In accordance with the user command, the fourth electronic apparatus 100-4 may identify a state of the electronic apparatus 100 by communicating with the electronic apparatus 100 that is connected to the fourth electronic apparatus 100-4 by wire or wirelessly, among the plurality of electronic apparatuses forming the IoT environment, or control the electronic apparatus 100 to perform the sub-service.

The electronic apparatus 100 may perform the sub-service based on the control signal received from the fourth electronic apparatus 100-4 which is capable of controlling the electronic apparatus 100.

The electronic apparatus 100, even when there is the fourth electronic apparatus 100-4 capable of controlling the electronic apparatus 100, may perform the operation as described with respect to the electronic apparatus 100, independently of the fourth electronic apparatus 100-4. That is, the electronic apparatus 100 may identify the first electronic apparatus 100-1 capable of performing the first sub-service among the plurality of sub-services for providing a service among the plurality of electronic apparatuses forming the IoT environment, transmit the information on the first application to perform the first sub-service received from the server 200 to the first electronic apparatus 100-2, receive, from the server 200, the second application to perform the second sub-service which the electronic apparatus 100 may perform, and perform the second sub-service through the second application that is received to provide a service in association with the first electronic apparatus 100-1 performing the first sub-service based on the information on the first application.

According to an embodiment as described above, when the host device is not capable of controlling at least one electronic apparatus in the IoT environment, as the host device leaves from the IoT environment (example: when the host device is out of a distance capable of communicating with at least one electronic apparatus among a plurality of electronic apparatuses forming the IoT environment, when the host device is not able to operate normally such as being damaged or terminated, when the host device is turned off according to a user command, or the like), the electronic apparatus 100 may, independently of the host device, transmit an application requested for another electronic apparatus among the plurality of electronic apparatuses forming the IoT environment to perform the sub-service to the another electronic apparatus, and provide a user with a service by performing the sub-service in association with the another electronic apparatus through the application.

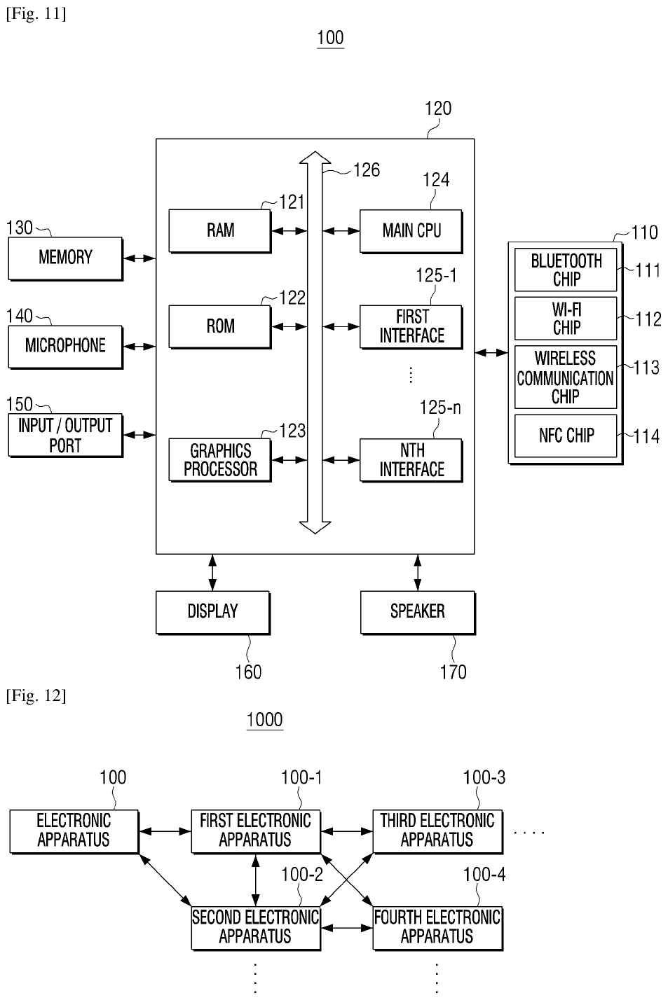

FIG. 11 is a block diagram which illustrates a configuration of an electronic apparatus in detail, according to an embodiment.

Referring to FIG. 11, the electronic apparatus 100 may further include one of a memory 130, a microphone 140, an input/output port 150, a display 160, and a speaker 170, in addition to the communicator 110 and the processor 120.

The communicator 110 may transmit and receive various types of data by performing communication with various types of external devices according to various types of communication methods. The communicator 110 may include at least one of a Bluetooth chip 111 for performing wireless communication, a Wi-Fi chip 112, a wireless communication chip 113, a near-field communication (NFC) chip 114, an Ethernet module (not shown) for performing wired communication, and a USB module (not shown). In this case, the Ethernet module (not shown) and the USB module (not shown) that perform wired communication may perform communication with an external device through the input/output port 150.

The processor 120 may include the RAM 121, the ROM 122, a graphics processor 123, a main CPU 124, first through n^{th} interfaces 125-1 through 125-n, and a bus 126. The RAM 121, the ROM 122, a graphics processor 123, a main CPU 124, first through n^{th} interfaces 125-1 through 125-n, or the like, may be interconnected through the bus 126.

The memory 130 may store programs and data necessary for an operation of the electronic apparatus 100.

The memory 130 may be implemented as a non-volatile memory, a volatile memory, a flash memory, a hard disk drive (HDD), a solid state drive (SSD), or the like. The memory 130 is accessed by the processor 120 and reading/writing/modifying/deleting/updating of data by the processor 120 may be performed. In the disclosure, the term memory may include the memory 130, random access memory (RAM) 121, read-only memory (ROM) 122 in the processor 120, or a memory card (for example, a micro SD card, a memory stick, or the like) mounted to the electronic apparatus 100.

The microphone 140 embedded in the electronic apparatus 100 may directly receive the user voice, and may obtain an audio signal by converting the user voice that is an analog signal to a digital signal by a digital converter (not shown).

The input/output port 150 is a configuration to connect the electronic apparatus 100 and an external device (not shown) by wire, so that the electronic apparatus 100 may transmit or receive an image and/or a signal about a voice with an external device (not shown).

For this purpose, the input/output port 150 may be implemented as a wired port such as high-definition multimedia interface (HDMI) port, a display port, a red-green-blue (RGB) port, a digital visual interface (DVI) port, Thunderbolt, component port, or the like.

In one example, the electronic apparatus 100 may receive the image and/or a signal of audio from the external device (not shown) through the input/output port 150, so that the electronic apparatus 100 may output an image and/or a voice. In another example, the electronic apparatus 100 may transmit a specific image and/or a signal of audio to an external device through the input/output port 150, so that an external device (not shown) may output the image and/or voice.

An image and/or a signal of an audio may be transmitted in a unidirectional manner through the input/output port 150. However, this is merely exemplary, and the image and/or a signal of an audio may be transmitted in a bidirectional manner through the input/output port 150.

The display 160 may display image data processed by an image processor (not shown) in a display area (or display). The display area may mean at least a portion of the display 160 exposed on one surface of the housing of the electronic apparatus 100. At least a portion of the display 110 may be coupled to at least one of a front area, a side area, and a rear area of the electronic apparatus 160 in the form of a flexible display. The flexible display may be characterized in that it may be bent, curbed, or rolled without a damage through a paper-like thin and flexible substrate.

The speaker 170 is embedded in the electronic apparatus 100 and may directly output various notification sounds or voice messages as well as various audio data in which various processing operations such as decoding, amplification, and noise filtering are performed by an audio processor (not shown).

The inputter (not shown) may receive various user inputs and transmit the user inputs to the processor 120. The inputter, for example, may include a touch panel, a (digital) pen sensor, or a key. The touch panel, for example, may use one of the capacitive, reducing, infrared, or ultrasonic method. In addition, a touch panel may further include a control circuit. The touch panel further includes a tactile layer, and it is possible to provide tactile response to the user. The (digital) pen sensor may, for example, be a part of a touch panel, or may include other recognition sheets. The key, for example, may include a physical button, an optical key, or keypad. The inputter (not shown) may be connected from an external device (not shown) such as a keyboard and a mouse by wire or wirelessly and receive a user input.

An IoT system 1000 according to an embodiment may include the first electronic apparatus 100-1 and the second electronic apparatus 100-2.

Here, the first electronic apparatus 100-1 may identify the second electronic apparatus 100-2 that may perform the first sub-service among a plurality of sub-services for providing a service, among a plurality of electronic apparatuses forming the IoT environment, and transmit the first application for the first sub-service received from the server 200 to the second electronic apparatus 100-2 capable of performing the first sub-service.

The first electronic apparatus 100-1 may receive, from the server 200, the second application for the second sub-service which the first electronic apparatus 100-1 may perform, among the plurality of sub-services, and perform the second sub-service through the received second application, in order to provide the service in association with the second electronic apparatus 100-2 performing the first sub-service, based on the information on the first application.

In this case, the second electronic apparatus 100-2 may perform the first sub-service by executing the first application, according to the information on the first application received from the first electronic apparatus 100-1, in order to provide the service in association with the first electronic apparatus 100-1 performing the second sub-service through the second application. In this case, the second electronic apparatus 100-2 may be an electronic apparatus identified by the first electronic apparatus 100-1 to perform the first sub-service among a plurality of electronic apparatuses forming the IoT environment.

This is merely exemplary, and the IoT system 1000 may include various numbers of electronic apparatuses, and the plurality of electronic apparatuses may form the IoT environment by performing communication in various combinations with each different electronic apparatus.

For example, referring to FIG. 12, the IoT system 1000 may include the electronic apparatus 100, the first electronic apparatus 100-1, the second electronic apparatus 100-2, the third electronic apparatus 100-3, the fourth electronic apparatus 100-4, E the n^{th} electronic apparatus (not shown). The electronic apparatus 100 may communicate with the first electronic apparatus 100-1, the second electronic apparatus 100-2, or the like, and the first electronic apparatus 100-1 may provide the service by performing the interlocked service by performing communication with the electronic apparatus 100, the second electronic apparatus 100-2, the third electronic apparatus 100-3, the fourth electronic apparatus 100-4, or the like.

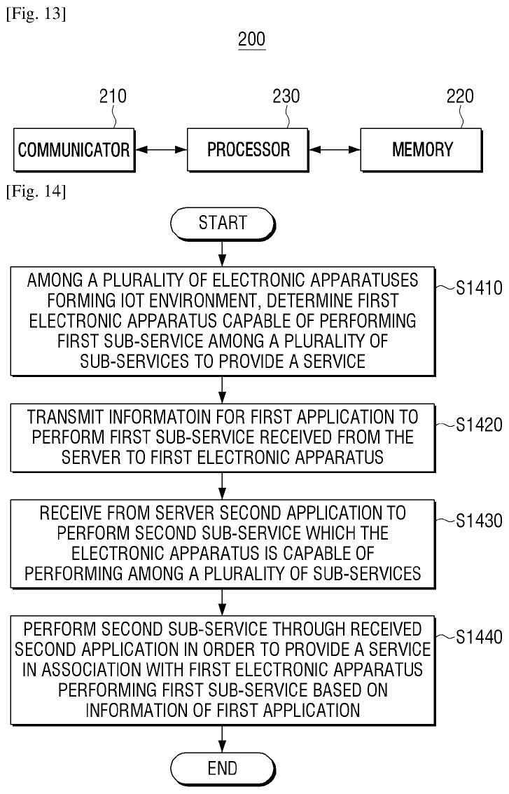

FIG. 13 is a block diagram of the server 200 according to an embodiment.

Referring to FIG. 13, the server 200 may include a communicator 210, a memory 220, and a processor 230. The server 200 may be implemented as an integrated server including the application store and the cloud server, as described above, but it may be implemented as a server system including each of the application store and the cloud server.

The communicator 210 may transceive various types of information by performing communication with various types of external devices such as the electronic apparatus 100, a plurality of electronic apparatuses (not shown) forming the IoT environment, and external electronic apparatuses according to various types of communication methods. In this case, the communicator 210 may be controlled by the processor 230.

For this purpose, the communicator 210 may include a Bluetooth chip for performing wireless communication according to the Bluetooth communication standard, a Wi-Fi chip for performing wireless communication according to the Wi-Fi communication standard, radio-frequency identification (RFID), wireless local area network (WLAN), global system for mobile communication (GSM), a wireless communication chip for performing wireless communication according to the communication standards such as 3G, 4G (including LTE), and 5G, the NFC chip, or the like.

The memory 220 may store information on an application and various programs (or data) necessary for an operation of the server 200, information requested to perform the sub-service through an application, or the like.

Here, the memory 220 is accessed by the processor 230, and reading/writing/modifying/deleting/updating of the data by the processor 230 may be performed. In this case, the memory 220 may include an internal memory or an external memory. In the meantime, the memory may be included inside the processor 230 or implemented as a storage device existing separately outside the processor 230. The description of the memory (not shown) of the electronic apparatus 100 may be equally applied.

The processor 230 may control overall operation of the server 200.

the processor 230 may transmit information on the application to the electronic apparatus 100 when a signal requesting to transmit information on the application from the electronic apparatus 100 is received through the communicator 210. The information on the application may include at least one of a package for installing the application or a URL for receiving the package from the server 200.

To be specific, the processor 230 may receive, from the electronic apparatus 100 forming the IoT, a signal requesting information on the application through the communicator 210. In this case, the processor 230 may search for information on the received application among the information on the plurality of applications stored (or registered) in the memory 220. The processor 230 may control the communicator 210 to transmit the information on the searched application to the electronic apparatus 100.

As another embodiment, the processor 230 may receive, from the electronic apparatus 100, information on the plurality of electronic apparatuses (the electronic apparatus 100 may be included) forming the IoT environment (or discovery information) through the communicator 210.

In this case, the processor 230 may identify the sub-service which the first electronic apparatus 100-1 may perform and the sub-service which the electronic apparatus 100 may perform, among the plurality of electronic apparatuses, based on the received information on the plurality of electronic apparatuses.

For example, if it is assumed that the sub-service which the first electronic apparatus 100-1, among the plurality of electronic apparatuses forming the IoT environment, is the first sub-service and the sub-service which the electronic apparatus 100 may perform is the second sub-service, the processor 230 may compare the received information on the plurality of electronic apparatuses and information requested to perform the plurality of sub-services, and identify that the first electronic apparatus 100-1 may perform the first sub-service, and that the electronic apparatus 100 may perform the second sub-service. This is merely exemplary, and the number of the plurality of electronic apparatuses forming the IoT may be changed in a various manner.

The processor 230, based on the received information on the plurality of electronic apparatuses, may transmit, to the electronic apparatus 100, information on the first application corresponding to the first sub-service, a distribution instruction that is set to transmit the information on the first application to the first electronic apparatus 100-1, and information on the second application corresponding to the second sub-service.

The electronic apparatus 100 may transmit the information on the first application to the first electronic apparatus 100-1 based on the received distribution instruction, and install the second application in the electronic apparatus 100. In this case, the electronic apparatus 100 may perform the second sub-service based on the received information on the second application, in order to provide the service in association with the first electronic apparatus 100-1 performing the first sub-service.

Furthermore, the processor 230 may transmit a user interface (UI) for an application to the electronic apparatus 100. The UI may include information on an application to be installed in the electronic apparatus 100 and information on an application to be transmitted to the plurality of electronic apparatuses forming the IoT environment.

In this case, the electronic apparatus 100 may output the received UI as an image (or sound) if the UI for the application is received. Upon receiving a user command to select an application to be installed in the electronic apparatus 100 or an application to be transmitted to the plurality of electronic apparatuses, the electronic apparatus 100 may transmit, to the server 200, a signal requesting information on the application to be installed in the electronic apparatus 100 or information on an application to be transmitted to the plurality of electronic apparatuses.

Based on the received signal, the processor 230 may control the communicator 210 to transmit, to the electronic apparatus 100, information on the application of the electronic apparatus 100, information on the application to be transmitted to the plurality of electronic apparatuses, and a distribution instruction configured to transmit the application to the plurality of electronic apparatuses.

In this case, the electronic apparatus 100, based on the received distribution instruction, may transmit information on the application to the plurality of electronic apparatuses and install the second application in the electronic apparatus 100.

The server 200 according to an embodiment as described above may provide information on applications for the plurality of electronic apparatuses to any one electronic apparatus of the plurality of electronic apparatuses forming the IoT environment at one time. Accordingly, even though all of the plurality of electronic apparatuses are not connected to the server 200 via the network, there is an advantage that an application may be distributed to the plurality of electronic apparatuses. In that the application may be distributed at one time, even if the individual user commands are not performed in each electronic apparatus, user convenience would be improved.

The server 200 may further include one of a microphone (not shown), an input/output port (not shown), a display (not shown), and a speaker (not shown), in addition to the memory 220 and the processor 230, and description as shown in FIG. 11 may be applied in the same manner.

FIG. 14 is a view to describe a flowchart according to an embodiment

First, the method for controlling the electronic apparatus 100 forming the Internet of Things (IoT) environment according to an embodiment may include, among a plurality of electronic apparatus forming the IoT environment, identifying the first electronic apparatus 100-1 capable of performing the first sub-service among the plurality of sub-services for providing the service in operation S1410.

The identifying the first electronic apparatus 100-1 may include identifying the first electronic apparatus 100-1 capable of performing the first sub-service among the plurality of electronic apparatuses based on the information on the plurality of electronic apparatuses received through the communicator 110.

The information on the first application for performing the first sub-service received from the server 200 may be transmitted to the first electronic apparatus 100-1 in operation S1420. Here, the information on the first application may include at least one of a package for installing the first application or the URL for receiving the package from the server 200.

The second application for performing the second sub-service which the electronic apparatus 100 may perform, among the plurality of sub-services, may be received from the server 200 in operation S1430.

Next, in order to provide a service in association with the first electronic apparatus 100-1 performing the first sub-service, based on the information non the first application, the second sub-service may be performed through the received second application in operation S1440.

The operation of performing the second sub-service may include performing the second sub-service by installing the received second application and executing the installed second application.

The method according to an embodiment may include identifying whether there is the alternative electronic apparatus 100′ capable of performing the second sub-service among the plurality of electronic apparatuses.

When the alternative electronic apparatus 100′ capable of performing the second sub-service is present, the information on the second application received from the server 200 may be transmitted to the alternative electronic apparatus 100′.

In this case, the alternative electronic apparatus 100′ may perform the second sub-service based on the information on the second application received from the electronic apparatus 100, in order to provide a service in association with the first electronic apparatus 100-1 performing the first sub-service based on the information on the first application.

In the meantime, the method according to an embodiment may include, upon receiving an instruction to request the third application to perform the third sub-service from the second electronic apparatus 100-2 among the plurality of electronic apparatuses, receiving the information on the third application from the server 200 and transmitting the received information on the third application to the second electronic apparatus 100-2 which transmitted the instruction.

In this case, the second electronic apparatus 100-2 may perform the third sub-service based on information on the third application received from the electronic apparatus 100, in order to provide a service in association with a different electronic apparatus among the plurality of electronic apparatuses.

The method according to an embodiment may include receiving a fourth application corresponding to the fourth sub-service for providing the service from the server 200 through the communicator 110, and performing the fourth sub-service through the received fourth application, in order to provide the service in association with the third electronic apparatus 100-3 that obtains the information on the fourth sub-service among the plurality of electronic apparatuses.

The performing of the fourth sub-service may include receiving, from the third electronic apparatus 100-3, information for the fourth sub-service acquired by the third electronic apparatus 100-3, and performing the fourth sub-service through the received fourth application based on the received information for the fourth sub-service.

The term “unit” or “module” used in the disclosure includes units consisting of hardware, software, or firmware, and is used interchangeably with terms such as, for example, logic, logic blocks, parts, or circuits. A “unit” or “module” may be an integrally constructed component or a minimum unit or part thereof that performs one or more functions. For example, the module may be configured as an application-specific integrated circuit (ASIC).

The embodiments of the disclosure may be implemented as software that includes instructions stored in machine-readable storage media readable by a machine (e.g., a computer). A device may call instructions from a storage medium and that is operable in accordance with the called instructions, including an electronic apparatus (e.g., the electronic apparatus 100). When the instruction is executed by a processor, the processor may perform the function corresponding to the instruction, either directly or under the control of the processor, using other components. The instructions may include a code generated or executed by the compiler or interpreter. The machine-readable storage medium may be provided in the form of a non-transitory storage medium. Here, “non-transitory” means that the storage medium does not include a signal and is tangible, but does not distinguish whether data is permanently or temporarily stored in a storage medium.

According to embodiments, a method disclosed herein may be provided in a computer program product. A computer program product may be traded between a seller and a purchaser as a commodity. A computer program product may be distributed in the form of a machine readable storage medium (e.g., CD-ROM) or distributed online through an application store (e.g., PlayStore [symbol] ). In the case of on-line distribution, at least a portion of the computer program product may be stored temporarily or at least temporarily in a storage medium such as a manufacturer's server, a server in an application store, or a memory in a relay server.

Each of the components (for example, a module or a program) according to the embodiments may be composed of one or a plurality of objects, and some subcomponents of the subcomponents described above may be omitted, or other subcomponents may be further included in the embodiments. Alternatively or additionally, some components (e.g., modules or programs) may be integrated into one entity to perform the same or similar functions performed by each respective component prior to integration. Operations performed by a module, program, or other component, in accordance with the embodiments, may be performed sequentially, in a parallel, repetitive, or heuristic manner, or at least some operations may be performed in a different order, omitted, or other operations can be added.

1. An electronic apparatus forming an internet of things (IoT) environment, comprising:
a communicator; and
a processor configured to:
from among a plurality of electronic apparatuses forming the IoT environment, identify a first electronic apparatus that is capable of performing a first sub-service among a plurality of sub-services to provide a service,
control the communicator to transmit, to the first electronic apparatus, information on a first application for performing the first sub-service that is received from a server,
receive, from the server, a second application for performing a second sub-service which the electronic apparatus is capable of performing,
among the plurality of sub-services, through the communicator, and
perform the second sub-service through the received second application to provide the service in association with the first electronic apparatus that performs the first sub-service based on information on the first application.

2. The electronic apparatus of claim 1, wherein the information on the first application comprises at least one of a package to install the first application or a uniform resource locator (URL) to receive the package from the server.

3. The electronic apparatus of claim 1, wherein the processor is configured to install the received second application in the electronic apparatus and perform the second sub-service by executing the installed second application.

4. The electronic apparatus of claim 1, wherein the processor is configured to identify the first electronic apparatus that is capable of performing the first sub-service, among the plurality of electronic apparatuses, based on information on the plurality of electronic apparatuses that is received from the plurality of electronic apparatuses through the communicator.

5. The electronic apparatus of claim 1, wherein the processor is configured to:
identify whether there is an alternative electronic apparatus that is capable of performing the second sub-service among the plurality of electronic apparatuses, and based on the alternative electronic apparatus that is capable of performing the second sub-service existing, control the communicator to transmit the received information on the second application to the alternative electronic apparatus,
wherein the alternative electronic apparatus is configured to perform the second sub-service based on the information on the second application received from the electronic apparatus, in order to provide the service in association with the electronic apparatus that performs the first sub-service based on the information on the first application.

6. The electronic apparatus of claim 5, wherein the processor is configured to, based on the alternative electronic apparatus performing the second sub-service, control not to perform the second sub-service through the second application.

7. The electronic apparatus of claim 1, wherein the processor is configured to:
based on receiving an instruction to request a third application for performing a third sub-service from a second electronic apparatus among the plurality of electronic apparatuses, receive, from the server, information on the third application through the communicator,
control the communicator to transmit the received information on the third application to the second electronic apparatus that transmits the instruction,
wherein the second electronic apparatus is configured to perform the third sub-service based on the information on the third application that is received from the electronic apparatus, in order to provide a service in association with a different electronic apparatus among the plurality of electronic apparatuses.

8. The electronic apparatus of claim 1, wherein the processor is configured to:
receive, from the server, a fourth application corresponding to a fourth sub-service to provide a service through the communicator, and
perform the fourth sub-service through the received fourth application, in order to provide the service in association with a third electronic apparatus that obtains information for the fourth sub-service, among the plurality of electronic apparatuses.

9. The electronic apparatus of claim 8, wherein the processor is configured to:
receive, from the third electronic apparatus, information for the fourth sub-service that is received by the third electronic apparatus, and
perform the fourth sub-service through the received fourth application based on the received information for the fourth sub-service.

10. An IoT system including a plurality of electronic apparatuses forming the IoT environment, comprising:
a first electronic apparatus; and
a second electronic apparatus to perform a first sub-service based on information on a first application that is received from the first electronic apparatus,
wherein the first electronic apparatus is further configured to:
identify the second electronic apparatus that is capable of performing a first sub-service among a plurality of sub-services to provide a service, among the plurality of electronic apparatuses,
based on receiving information on a first application for performing the first sub-service from a server, transmit information on the first application to the second electronic apparatus,
receive, from the server, a second application for performing a second sub-service which the first electronic apparatus is capable of performing, among the plurality of sub-services, and
perform the second sub-service through the received second application, in order to provide the service in association with the second electronic apparatus that performs the first sub-service based on the information on the first application.

11. A controlling method of an electronic apparatus forming an internet of things (IoT) environment, the method comprising:
from among a plurality of electronic apparatuses forming the IoT environment, identifying a first electronic apparatus that is capable of performing a first sub-service among a plurality of sub-services to provide a service;
transmitting, to the first electronic apparatus, information on a first application for performing the first sub-service that is received from a server;
receiving, from the server, a second application for performing a second sub-service which the electronic apparatus is capable of performing, among the plurality of sub-services; and
performing the second sub-service through the received second application to provide the service in association with the first electronic apparatus that performs the first sub-service based on information on the first application.

12. The method of claim 11, wherein the information on the first application comprises at least one of a package to install the first application or a uniform resource locator (URL) to receive the package from the server.

13. The method of claim 11, wherein the performing the second sub-service further comprises:
installing the received second application; and
performing the second sub-service by executing the installed second application.

14. The method of claim 11, wherein the identifying the first electronic apparatus comprises:
identifying the first electronic apparatus that is capable of performing the first sub-service, among the plurality of electronic apparatuses,
based on information on the plurality of electronic apparatuses that is received from the plurality of electronic apparatuses through the communicator.

15. The method of claim 11, further comprising:
identifying whether there is an alternative electronic apparatus that is capable of performing the second sub-service among the plurality of electronic apparatuses; and
based on the alternative electronic apparatus that is capable of performing the second sub-service existing, transmitting the received information on the second application to the alternative electronic apparatus,
wherein the alternative electronic apparatus is configured to perform the second sub-service based on the information on the second application received from the electronic apparatus, in order to provide the service in association with the electronic apparatus that performs the first sub-service based on the information on the first application.
